(19) United States
(12) Patent Application Publication
(10) Pub. No.: US 2023/0412512 A1
(43) Pub. Date: Dec. 21, 2023

(54) DATA TRAFFIC REDUCTION FOR REDUNDANT DATA STREAMS

(71) Applicants: Tomasz Madajczak, Gdansk (PL); Pawel SZYMANSKI, Gdansk (PL); Raul DIAZ, Palo Alto, CA (US); Intel Corporation, Santa Clara, CA (US)

(72) Inventors: Tomasz Madajczak, Gdansk (PL); Pawel Szymanski, Gdansk (PL); Raul Diaz, Palo Alto, CA (US)

(21) Appl. No.: 18/038,359

(22) PCT Filed: Dec. 23, 2020
(86) PCT No.: PCT/US2020/066940

§ 371 Date: May 23, 2023

(51) Int. Cl. H04L 47/2416; H04L 47/12; H04L 49/90

(52) U.S. Cl. CPC H04L 47/2416; H04L 47/12; H04L 49/9078

(57) ABSTRACT

Systems and methods are disclosed for reducing processing for received redundant data streams. A first network controller receives a first stream of data packets and a second network controller receives a second stream of data packets redundant to the first stream. The first network controller determines, using a value of an identifier of a received packet of the first stream of data packets, that a corresponding packet of the second stream of data packets having the value of the identifier has not already been received. In response to the determining, the first network controller outputs the first data packet. The second network controller determines, using a value of an identifier of a second packet of the second stream of data packets, that the first data packet has already been received and drops the second packet in response to the determining.

### TECHNICAL FIELD

Embodiments described herein generally relate to data streaming and in particular, to reducing processing for received redundant data streams.

### BACKGROUND

To mitigate against rare random packet losses for data transmission, some systems transmit redundant data streams. For example, some industry standards, such as Society of Motion Picture and Television Engineers (SMPTE) St2022-6 and SMPTE St2110-21 for professional video production, use seamless redundancy of data traffic sent from capture devices or systems to computing systems that consume the video or other data.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing;

FIG. 2 is a diagram illustrating a conventional system for handling redundant data streams;

FIG. 3 is a diagram illustrating a network interface for handling redundant data streams according to an example;

FIG. 4 is a diagram illustrating network interfaces for handling redundant data streams according to an example;

FIG. 5 is a flowchart illustrating an example method of handling redundant data streams to reduce data traffic to a processor;

FIG. 6 is a diagram illustrating an example method of handling redundant data streams to reduce data traffic to a processor;

FIG. 7 is a diagram illustrating network interfaces for handling redundant data streams according to an example;

FIG. 8 is a flowchart illustrating a method of servicing redundant data streams according to an example;

FIG. 9 is a diagram illustrating an example method of handling redundant data streams to reduce data traffic to a processor;

FIG. 10 is a block diagram illustrating an example of a machine upon which one or more embodiments may be implemented; and

FIG. 11 illustrates an example software distribution platform to distribute software to one or more devices.

### DETAILED DESCRIPTION

Systems and methods for receiving and processing purposefully redundant data traffic are disclosed herein. First and second network interface controllers (NICs) receive redundant data streams through respective network interfaces. Each NIC extracts a unique identifier, such as Real-time Transport Protocol (RTP) sequence identifier (ID) for each respective data packet. The respective NIC determines if the other NIC has already processed a packet with a same unique identifier for a same data flow. If so, the respective NIC silently drops the data packet. If not, the respective NIC supplies the data packet for consumption by an application, for example, by outputting the packet to a central processing unit (CPU), outputting the packet to a receive buffer using direct memory access (DMA), or the like.

In an example, a lookup table may be implemented to track which data packets have already been processed for a respective redundant data flow. When a data packet is received by a respective NIC, a unique identifier for the data flow, such as an RTP sequence ID, may be used along with a queue ID for the data flow to index into the lookup table. A value stored by the lookup table at the respective address may be read and then incremented using an atomic count operation, for example. This way, both NICs cannot read and increment the value at the same time, allowing the value to act as a semaphore. If the value from the lookup table is zero, the NIC determines that the respective packet has not been processed by either NIC. If the value is non-zero, the respective NIC knows that the respective packet has been processed by the other NIC. In an example, a prefect hash function may be used to index into the lookup table using the unique identifier and the queue ID.

In another example, rather than using a lookup table, a value in the output buffer for the data flow may be used to identify whether a respective packet has already been received by a respective NIC. For example, a receive buffer may be allocated in memory for a data flow for a respective video frame. Each storage location in the receive buffer for each respective packet may include a field for an atomic counter or other semaphore. Upon receipt of a packet, the respective NIC may use a unique identifier for the packet, such as an RTP sequence ID and a queue ID for the respective data flow, to obtain a respective address for the packet within the receive buffer. Using the address, the respective NIC can perform a fetch and add operation on the value stored at the address. If the value stored at the address is zero, the NIC determines that the respective packet has not have been processed by either NIC. If the value is non-zero, the respective NIC knows that the respective packet has been processed by the other NIC and the packet can be silently dropped. In an example, a prefect hash function may be used to index into the receive buffer using the unique identifier and the queue ID. In this example, the NICs may generate an interrupt or other signal for the CPU or graphics processing unit (GPU) to indicate that the packet has been written to the output buffer.

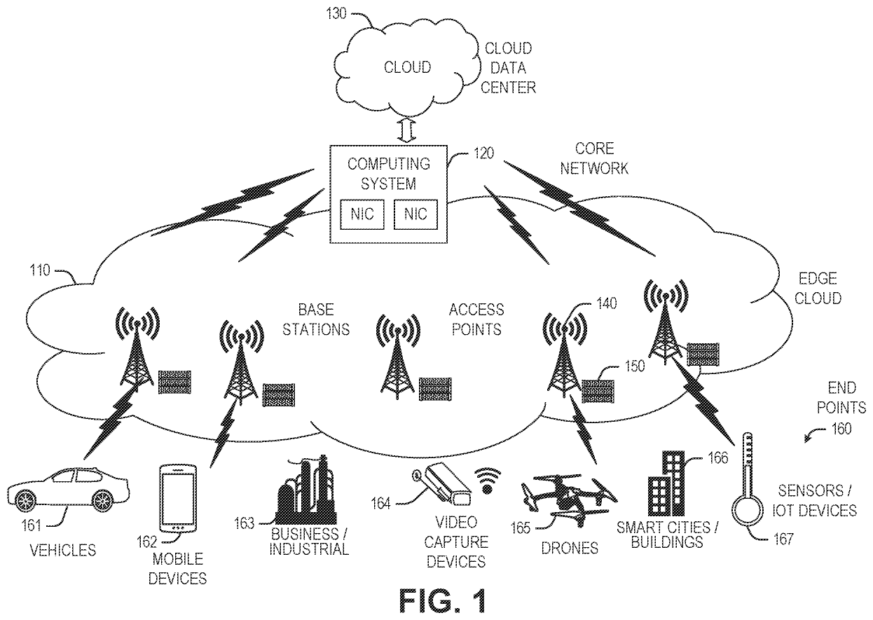

In some examples, a computing system including multiple NICs for receiving purposefully redundant data streams may be implemented in an edge computing environment. FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or other computing system 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

The computing device 120 may be any computing system including a laptop computer, desktop computer, server, or other computing system. The computing device 120 includes multiple network interface controllers (NICs) capable of receiving separate redundant data streams. For example, Society of Motion Picture and Television Engineers (SMPTE) St2022-6 and SMPTE St2110-21 for professional video production, use seamless redundancy of data traffic sent from capture devices or systems to a computing systems that consume the video or other data. For example, video capture devices 164 may transmit redundant video data to the computing device 120, with each NIC receiving a respective redundant stream. Each data stream in these protocols may be received by separate NICs. While illustrated and described as an edge network, the systems and methods discussed herein may be employed in any network in which redundant data is transmitted.

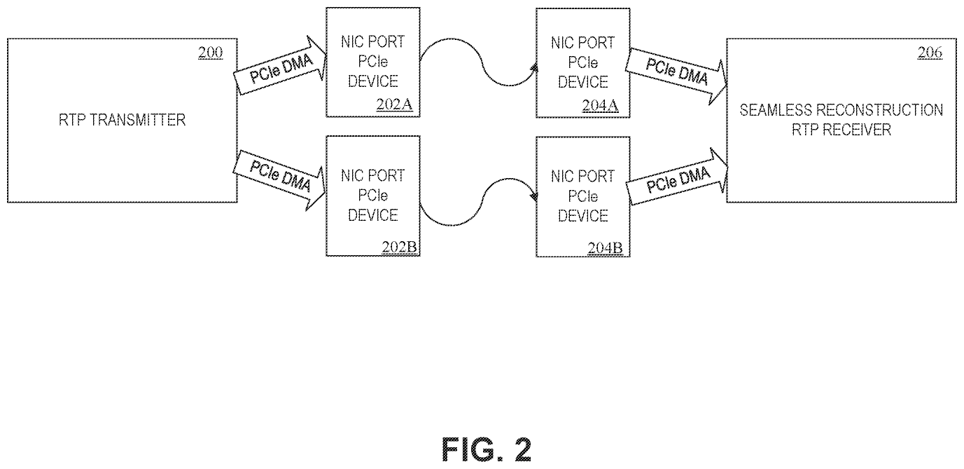

FIG. 2 is a diagram illustrating a conventional system for handling redundant data streams. Industry standards of professional video production such as, for example SMPTE St2022-6 and SMPTE St2110-21, to mitigate a rare random packet loss (that can happen on network switches due to higher priority traffic for example) use seamless redundancy of traffic sent in the production studios as depicted on FIG. 2. An RTP transmitter 200 transmits the redundant data streams through NICs 202A and 202B to respective NICs 204A and 204B. The respective NICs 204A and 204B each push every received data packet onto the bus to the RTP receiver 206. This results in twice as many bus transfers of data packets as is necessary for each video frame.

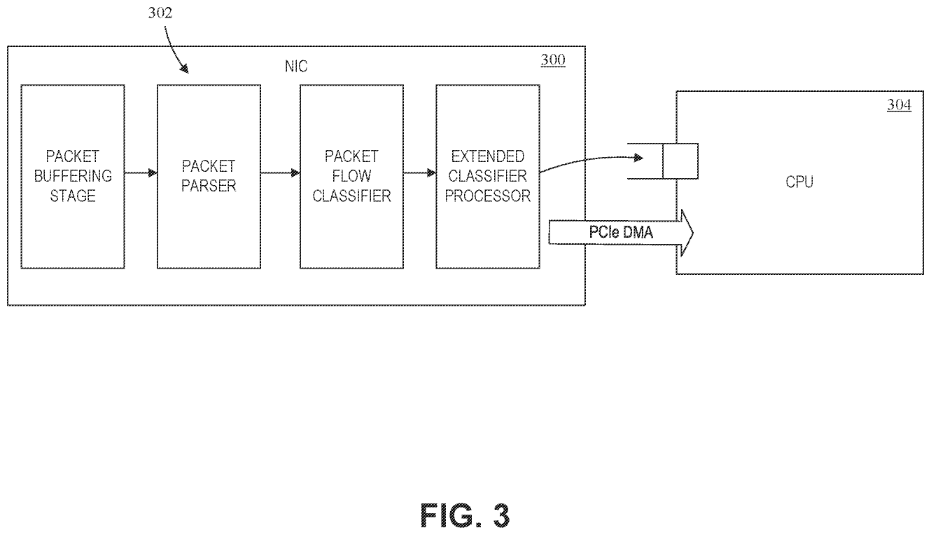

To combat this issue, each NIC may execute operations to reduce the total amount of traffic pushed on the data bus. FIG. 3 is a diagram illustrating a network interface for handling redundant data streams according to an example. Each NIC 300 has a packet processing pipeline 302 in hardware, for example, as illustrated on FIG. 3. The pipeline is configurable to detect user datagram protocol (UDP) sessions by, for example, a 5-tuple flow classifier and can also be configured to perform decapsulation of RTP protocol, such as RFC4175 RTP for professional raw video, for example. From that protocol, for example, the NIC pipeline may extract an RTP protocol sequence ID field of 16-32 bits (RFC 4175 uses extension to 32 bits), which can be input to a PerfectHash function.

The PerfectHash function calculates an address of a synchronization value that is atomically fetched and incremented over peripheral component interconnect express (PCIe), by each of the 2 concurring NICs, and works as a mutual exclusion semaphore allowing only the first NIC to succeed. The NIC that entered the semaphore first performs the PCIe transaction and pushes the packet into the receive buffer for the CPU 304, while the other NIC drops the packet silently.

Optionally. The receive buffers can be also assigned orderly to the NIC receive queue, so that PerfechHash can calculate destination addresses so that the respective NIC can push each packet payload directly to that address. This way, video buffers can be filled by the NIC DMA and can reside in CPU memory or in GPU memory, so that the packet data can be immediately used after receiving. To support this capability fully, the ability to trigger a doorbell interrupt on the GPU or CPU, or increment a polled by software value is utilized.

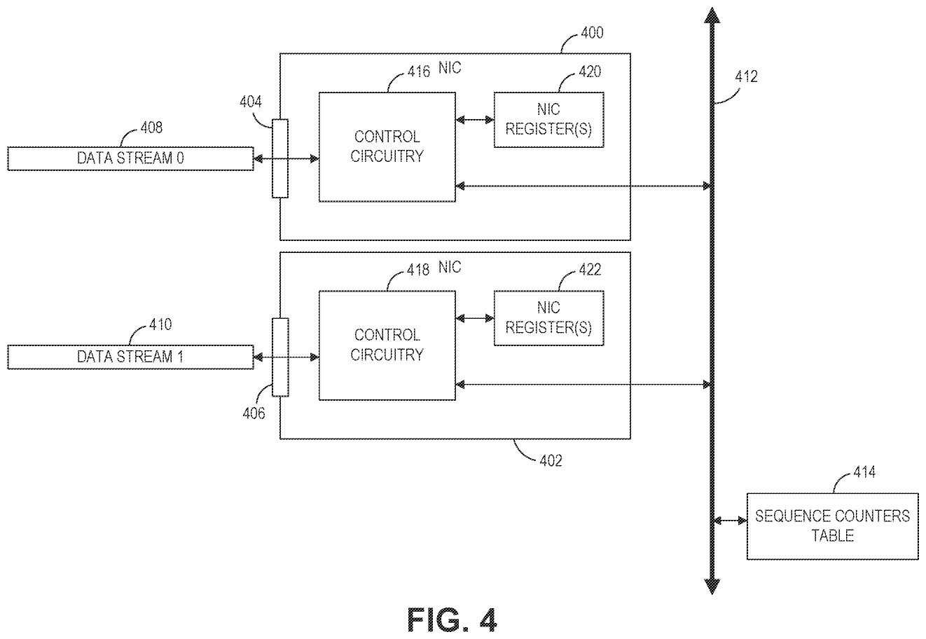

FIG. 4 is a diagram illustrating network interfaces 400 and 402 for handling redundant data streams according to an example. FIG. 4 includes two network interface controllers (NICs) 400 and 402 such as for the computing system 120. The NICs 400 and 402 are configured to receive data transmissions through the respective network interfaces 404 and 406. These interfaces 404 and 406 may be physical connectors, such as Ethernet connectors, or may be antennas, such as transceivers for communicating on wireless networks, such as Wi-Fi, for example. For redundant data transmissions, each NIC 400 and 402 may receive a respective redundant data stream 408 and 410 through the respective interfaces 404 and 406.

Each NIC 400 and 402 is configured to communicate with other components of the computing system over a bus 412. The bus 412 may be used to communicate data using any protocol, such as a peripheral component interconnect express (PCIe) and may be connected to a central processing unit (CPU), graphics processing unit (GPU), one or more memory storage devices, or any other component. In the example shown in FIG. 4, a sequence counters table 414 is implemented in one or more memory storage devices of the computing system such as a system main memory, or any other memory device of the system within which the NICs 400 and 402 are connected. The NICs 400 and 402 are be configured to read and write values of the sequence counters table 414 over the bus 412.

The sequence counters table 414 may be implemented as a lookup table, for example, configured to store values for respective packets of respective data flows. Each data flow may be assigned a queue identifier indicating a receive queue into which the data is written for the CPU, GPU, or other device or application to consume. The sequence counters table 414 may be initialized for each new flow based on the queue ID for the respective flow such that all values in the sequence counters table 414 for the respective flow are initially zero.

At the beginning of a data flow, an application executed by the CPU or other device may allocate the sequence counters table 414, which is common for the both NICs 400 and 402. The application may also program within a NIC register 420 or 422 of each of the respective NICs 400 and 402, a base address in memory for the sequence counters table 414 for a respective data flow. Each NIC 400 and 402 can use the value in the respective registers 420 and 422 to index into the sequence counters table 414 for the respective data flow.

Each NIC 400 and 402 may execute a perfect hash function, for example, or any other function to index into the sequence counters table using a unique identifier. Each respective data stream 408 and 410 may include many data packets. Each packet may include a field that contains a unique identifier. To index into the sequence counters table 414, each NIC 400 and 402 may use the unique identifier, such as an RTP sequence ID, from the received packet of the respective data stream 408 and 410, as well as the base address stored in the respective register 420 and 422. The sequence counters table 414 may store values, such as atomic count values, unique to each unique identifier of each data flow. If the stored value is zero, the respective NIC 400 or 402 may determine that the packet has not yet been received by the other NIC 400 or 402 and output the packet on the bus 412 for consumption by an application, for example. The NIC 400 or 402 may also increment the count so that the other NIC 400 or 402 is able to silently drop the redundant packet upon receipt of the redundant packet.

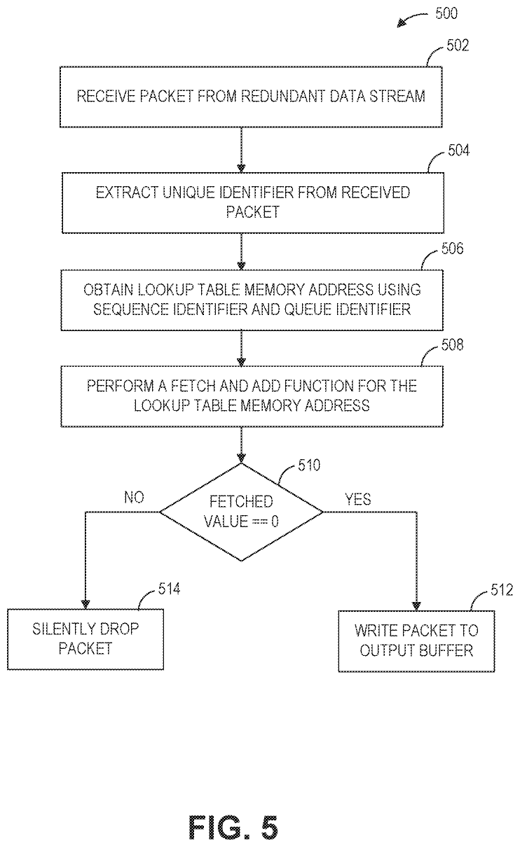

FIG. 5 is a flowchart illustrating an example method 500 of handling redundant data streams to reduce data traffic to a processor. The method 500 may service redundant data streams, such as the redundant data streams 408 and 410 to reduce bus traffic for a central processing unit (CPU), for example, on the bus 412. The method 500 may be executed by the control circuitry 416 and 418 of the respective NICs 400 and 402. At step 502, a packet is received by one of multiple NICs connected to the bus. The respective NIC may perform a 5 tuple classification to classify a user datagram protocol (UDP) flow, for example. The received packet is part of a redundant data stream, such as a redundant video stream transmitted according to SMPTE St2022-6 or SMPTE St2110-21. The respective NIC that received the packet assigns a queue ID to indicate to which receive queue the packet is directed, so that an application can receive from that queue later.

At step 504, a unique identifier is extracted from the received packet. In an example, this may be an RTP sequence ID for a UDP flow or may be any other unique identifier for the packet within the redundant data stream. At step 506, the respective NIC obtains a lookup table memory address using the unique identifier and queue identifier. In an example, this may be accomplished using a perfect hash function with the unique identifier and the queue identifier as input. For example, the queue identifier may be a base address for the lookup table within a larger memory structure. The result of the perfect hash function is a memory address unique for the flow and unique identifier. The lookup table may store a respective atomic count value for each lookup table entry.

At step 508, a fetch and add function may be initiated by the NIC, for example, to increase the atomic count value stored at the address provided for the sequence counter table. This counter acts as a semaphore such that only one NIC can update the value at a time, ensuring that the first NIC to attempt to update the value is successful. In other examples, any other method of implementing a semaphore within the lookup table entry may be used. At step 510, if the fetched value is equal to 0, then the standard packet receive function for the NIC is performed, for example, to push the received packet over the bus to the CPU memory at step 512. If the fetched value is not equal to 0, then the packet is silently dropped at step 514. This method 500 reduces the total amount of traffic sent over the bus to the CPU by only sending one of each redundant packet to the application, reducing bus traffic by up to 50% for each redundant data stream.

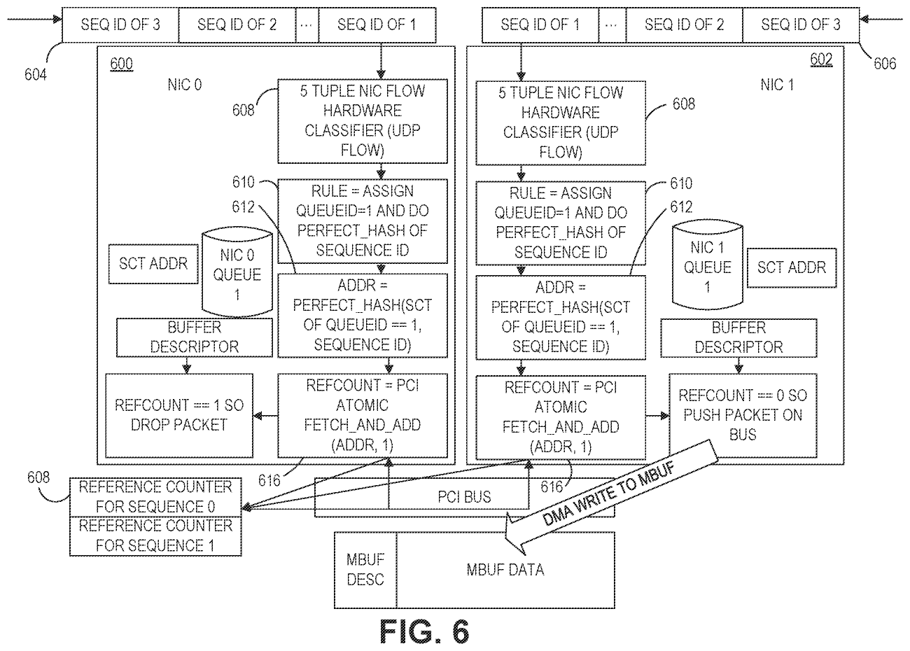

FIG. 6 is a diagram illustrating an example implementation of the method 500 for two NICs 600 and 602. Each NIC 600 and 602 receives redundant data packets 604 and 606. An application allocates the Sequence Counters Table 608 that is common for both NICs 600 and 602 and programs within each NIC register the base address that table. Each NIC 600 and 602 accesses that respective register during execution of a PERFECT_HASH function.

In this example, ST2110-21 UDP flows, for example, are classified in the NIC hardware (by a flow hardware classifier/director) and the classification indicates that the NIC shall perform a dedicated algorithm for the packet illustrated by operations 610-616 in each NIC. The algorithm includes the following operations:
610: Assign a queue ID to which a packet is directed, so that the application can receive from that queue later;
612: Perform a PERFECT_HASH function on the RTP sequence ID value for the respective packet. The result of that function is unique for the flow and sequence ID and indicates a CPU memory address of the respective atomic counter;
614: Perform PCI_FETCH_AND_ADD(address, 1) PCIe transaction using the CPU memory address calculated in the previous step, which adds 1 in for that transaction and fetches the previous value at that memory address, referred to as the REF_COUNT.
616: If REF_COUNT is equal to 0 then the standard packet receive on the NIC is launched (so that the packet is pushed over the PCIe bus to the CPU memory). If REF_COUNT is different than 0 then the packet is silently dropped. In some examples, a statistic of dropped packets for the purpose of hardware feature validation may be implemented.

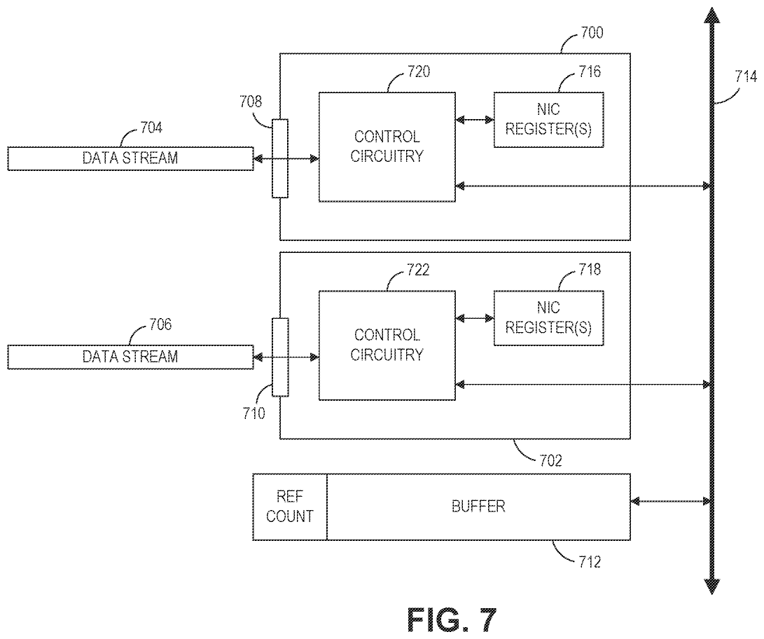

FIG. 7 is a diagram illustrating network interfaces for handling redundant data streams according to an example. In particular, FIG. 7 is a block diagram illustrating another example system that includes two network interface controllers (NICs) 700 and 702. The hardware for the NICs 700 and 702 may be substantially similar to the hardware for the NICs 700 and 702 of FIG. 7. Each NIC 700 and 702 receives a respective redundant data stream 704 and 706. Each NIC 700 and 702 receives the redundant data streams 704 and 706 through respective network interfaces 708 and 710. These interfaces 708 and 710 may be physical connectors, such as Ethernet connectors, or may be antennas, such as transceivers for communicating on wireless networks, such as Wi-Fi, for example.

The NICs 700 and 702 may be configured to perform direct memory access writes directly to a receive buffer 712 accessible by a CPU, GPU, or other device or application. The receive buffer 712 may be allocated in such a way that each memory location for each received packet may include a field that stores an atomic counter or other semaphore. This way, the sequence counters table 414 of FIG. 4 is not needed. The queue ID and the unique identifier of the packet can be used to identify the memory location for a respective packet within the receive buffer 712, and the atomic counter value can be read from the buffer 712 for the respective unique ID and queue ID. A base address for the receive buffer for a respective flow may be stored by a respective register 716 and 718. A significant advantage of the system illustrated in FIG. 7 is that the buffer 712 is common to both NICs 700 and 702, reducing the amount of memory space required by the system.

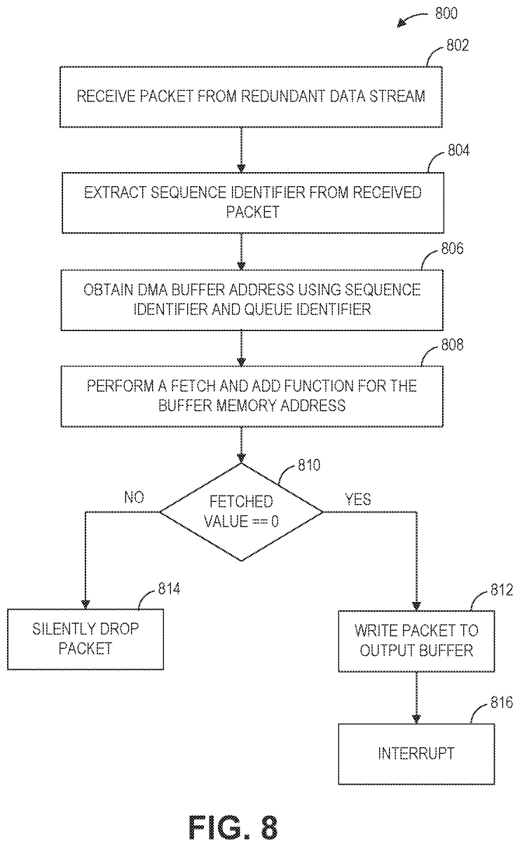

FIG. 8 is a flowchart illustrating a method 800 of servicing redundant data streams, such as the redundant data streams 704 and 706 to reduce bus traffic for a central processing unit (CPU), for example, on the bus 714. The method 800 may be executed by the control circuitry 720 and 722 of the respective NICs 700 and 702, for example. At step 802, a packet is received by one of multiple NICs connected to the bus and classified using a 5 tuple classification, for example. The packet is part of a redundant data stream, such as a redundant video stream transmitted according to SMPTE St2022-6 or SMPTE St2110-21. The respective NIC assigns a queue ID to indicate to which receive buffer the packet is directed, so that an application can receive from that queue later. The receive buffer may be implemented in a memory storage device accessible by a GPU, for example, and writeable through DMA by the NICs 700 and 702.

At step 804, a unique identifier is extracted from the received packet. In an example, this may be an RTP sequence ID for a UDP flow or may be any other unique identifier for the packet within the redundant data stream. At step 806, the respective NIC obtains a receive buffer address using the unique identifier and queue identifier. In an example, this may be accomplished using a perfect hash function with the unique identifier and the queue identifier as input. For example, the queue identifier may be a base address for the respective output buffer stored in a register of the respective NIC 700 and 702. The result of the perfect hash function is an address unique for the flow and unique identifier. The buffer address may store a respective atomic count value for the respective unique identifier, or any other value that can be used as a semaphore for the received packet.

At step 808, a fetch and add function is performed by the NIC to increase the atomic counter stored at the address provided for the output buffer. This counter acts as a semaphore such that only one NIC can update the value at a time, ensuring that the first NIC to attempt to update the value is successful. At step 810, if the fetched value is equal to 0, then the packet data is output at step 812 to the buffer location indicated by the address. If the fetched value is not equal to 0, then the packet is silently dropped at step 814. The method 800 may also include generating, by the NIC, an interrupt or other signal to indicate to a CPU or GPU, for example, that the data is in the receive buffer (step 816).

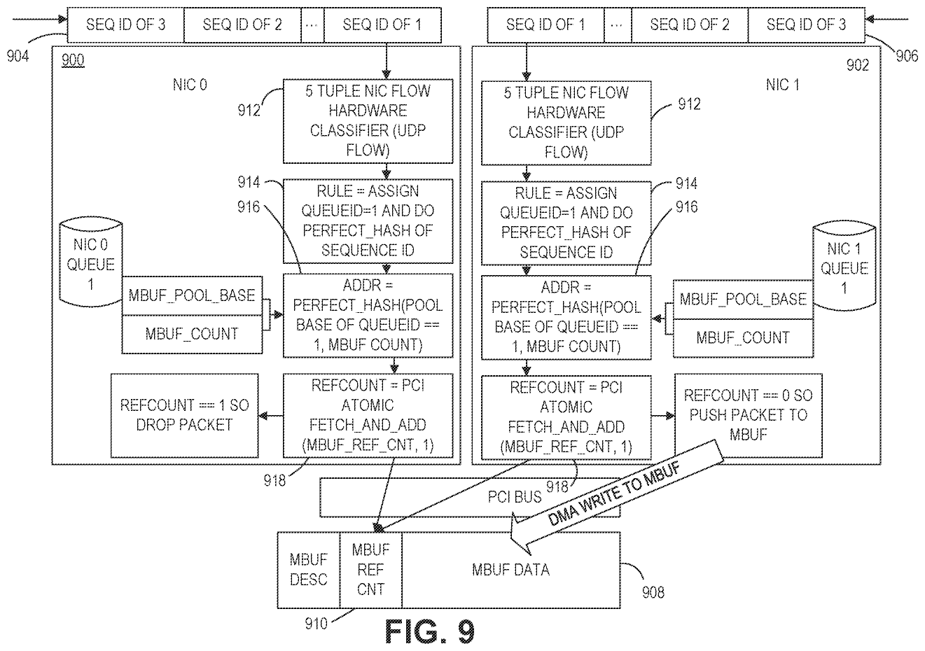

FIG. 9 is a diagram illustrating an example implementation of the method 800 for two NICs 900 and 902. Each NIC 900 and 902 receives redundant data packets 904 and 906. Each NIC 900 and 902 is capable of transporting packet payloads directly into a desired video buffer 908 that may be accessible from a GPU (or implemented in the GPU memory directly). In this example, each UDP RTP flow has an assigned dedicated buffer pool in which each buffer points directly to the video buffer location where the received packet is within the respective video frame. This implementation has the advantage of reducing the amount of buffer resources used by both NICs 900 and 902 as they each share the same buffer pool for each UDP RTP flow.

Instead of the Sequence Counters Table of FIG. 6, the location 910 in the buffer descriptor can be used as an atomic reference counter. Therefore, the buffer pool base address is common for both NICs 900 and 902, and the base address is programmed within each NIC register for that pool. Additionally, the count of buffers in the pool shall be programmed in each NIC 900 and 902 along with the expected descriptor and payload size. Each NIC will be accessing these values during a PERFECT_HASH function. UDP RTP flows are classified in the NIC hardware (by a flow hardware classifier/director) and each NIC 900 and 902 performs operations 912-918 for the respective packet:
912: Assign a queue ID to which the packet is directed, so that the application can receive from that queue later after DMA transfers are complete;
914: Perform a PERFECT_HASH function using the RTP sequence ID value. The result of the function is unique and indicates an address of the packet buffer to which to copy the payload or the address of the video buffer if pushing the packet to GPU memory directly.
916: Perform a PCI_FETCH_AND_ADD(address, 1) PCIe transaction using the CPU memory address calculated in operation 910, which adds 1 to the value and fetches the previous value (REF_COUNT) stored at that memory address.
918: If REF_COUNT is equal to 0 then the customized packet receive on the respective NIC 900 or 902 is launched so that the packet is pushed over PCIe to the correct buffer or directly into CPU/GPU video frame memory. It is desirable that upon DMA completion, a doorbell on the CPU or GPU is used to inform that the packet is received, and/or increment a counter to accommodate polling by the CPU/GPU. If REF_COUNT is different than 0, the packet is silently dropped. A statistic of dropped packets for the purpose of hardware feature validation may also be implemented.

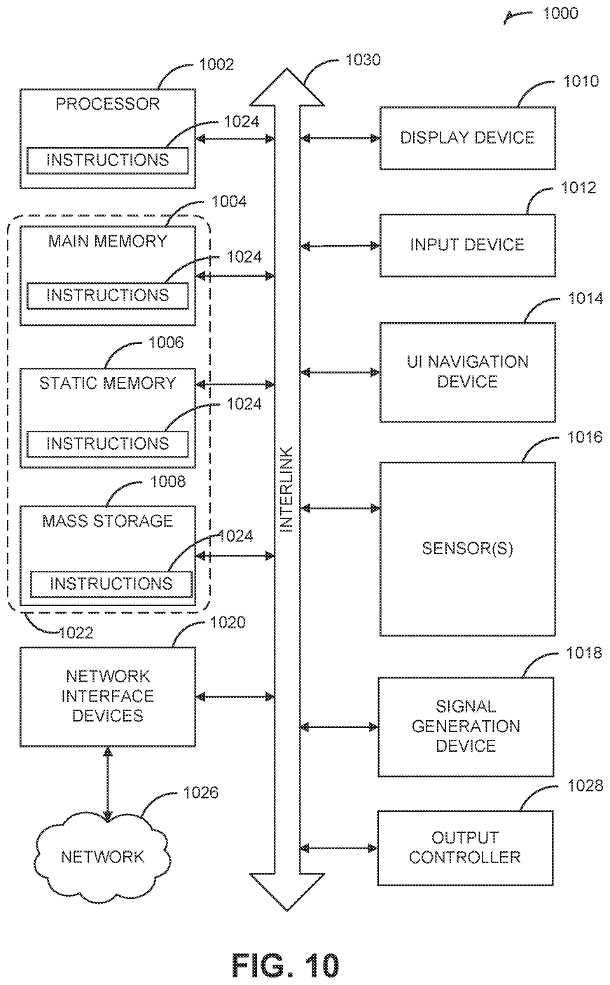

FIG. 10 illustrates a block diagram of an example machine 1000 upon which any one or more of the techniques (e.g., methodologies) discussed herein may perform. Examples, as described herein, may include, or may operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1000 follow.

In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1000 may include a hardware processor 1002 (e.g., a central processing unit (CPU), a graphics processing unit (GPU), a hardware processor core, or any combination thereof), a main memory 1004, a static memory (e.g., memory or storage for firmware, microcode, a basic-input-output (BIOS), unified extensible firmware interface (UEFI), etc.) 1006, and mass storage 1008 (e.g., hard drives, tape drives, flash storage, or other block devices) some or all of which may communicate with each other via an interlink (e.g., bus) 1030. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1008, a signal generation device 1018 (e.g., a speaker), a network interface device 1020, and one or more sensors 1016, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1002, the main memory 1004, the static memory 1006, or the mass storage 1008 may be, or include, a machine readable medium 1022 on which is stored one or more sets of data structures or instructions 1024 (e.g., software) embodying or utilized by any one or more of the techniques or functions described herein. The instructions 1024 may also reside, completely or at least partially, within any of registers of the processor 1002, the main memory 1004, the static memory 1006, or the mass storage 1008 during execution thereof by the machine 1000. In an example, one or any combination of the hardware processor 1002, the main memory 1004, the static memory 1006, or the mass storage 1008 may constitute the machine readable media 1022. While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1022 may be representative of the instructions 1024, such as instructions 1024 themselves or a format from which the instructions 1024 may be derived. This format from which the instructions 1024 may be derived may include source code, encoded instructions (e.g., in compressed or encrypted form), packaged instructions (e.g., split into multiple packages), or the like. The information representative of the instructions 1024 in the machine readable medium 1022 may be processed by processing circuitry into the instructions to implement any of the operations discussed herein. For example, deriving the instructions 1024 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1024.

In an example, the derivation of the instructions 1024 may include assembly, compilation, or interpretation of the information (e.g., by the processing circuitry) to create the instructions 1024 from some intermediate or preprocessed format provided by the machine readable medium 1022. The information, when provided in multiple parts, may be combined, unpacked, and modified to create the instructions 1024. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1024 may be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, 3GPP 4G/5G wireless communication networks), Bluetooth or IEEE 802.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software. A transmission medium is a machine readable medium.

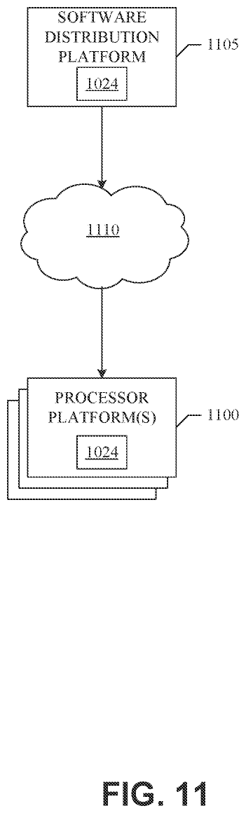

FIG. 11 illustrates an example software distribution platform 1105 to distribute software, such as the example computer readable instructions 1024 of FIG. 10, to one or more devices, such as example processor platform(s) 1000 and/or example connected edge devices. The example software distribution platform 1005 may be implemented by any computer server, data facility, cloud service, etc., capable of storing and transmitting software to other computing devices (e.g., third parties, the example connected edge devices 161-166 of FIG. 1). Example connected edge devices may be customers, clients, managing devices (e.g., servers), third parties (e.g., customers of an entity owning and/or operating the software distribution platform 1105). Example connected edge devices may operate in commercial and/or home automation environments. In some examples, a third party is a developer, a seller, and/or a licensor of software such as the example computer readable instructions 1024 of FIG. 10. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 11, the software distribution platform 1105 includes one or more servers and one or more storage devices. The storage devices store the computer readable instructions 1024, which may correspond to the example computer readable instructions 1024 of FIG. 10 as described above. The one or more servers of the example software distribution platform 1105 are in communication with a network 1110, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1024 from the software distribution platform 1105. For example, the software, which may correspond to the example computer readable instructions 1024 of FIG. 10, may be downloaded to the example processor platform(s) 1100 (e.g., example connected edge devices), which is/are to execute the computer readable instructions 1024 to implement the named function network function generation described herein. In some examples, one or more servers of the software distribution platform 1105 are communicatively connected to one or more security domains and/or security devices through which requests and transmissions of the example computer readable instructions 1024 must pass. In some examples, one or more servers of the software distribution platform 1105 periodically offer, transmit, and/or force updates to the software (e.g., the example computer readable instructions 1024 of FIG. 10) to ensure improvements, patches, updates, etc. are distributed and applied to the software at the end user devices.

In the illustrated example of FIG. 11, the computer readable instructions 1024 are stored on storage devices of the software distribution platform 1105 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1024 stored in the software distribution platform 1105 are in a first format when transmitted to the example processor platform(s) 1100. In some examples, the first format is an executable binary in which particular types of the processor platform(s) 1100 can execute. However, in some examples, the first format is uncompiled code that requires one or more preparation tasks to transform the first format to a second format to enable execution on the example processor platform(s) 1100. For instance, the receiving processor platform(s) 1100 may need to compile the computer readable instructions 1024 in the first format to generate executable code in a second format that is capable of being executed on the processor platform(s) 1100. In still other examples, the first format is interpreted code that, upon reaching the processor platform(s) 1100, is interpreted by an interpreter to facilitate execution of instructions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a system for reducing data traffic for redundant data streams, the system comprising: a first network interface controller comprising one or more hardware processors and one or more memories, storing instructions, which when executed, cause the one or more hardware processors to perform first operations comprising: receiving a first stream of data packets redundant to a second stream of data packets; determining, using a value of an identifier of a received packet of the first stream of data packets, that a corresponding packet of the second stream of data packets having the value of the identifier has not already been received; in response to the determining, outputting the first data packet; and setting a stored value corresponding to the identifier, the stored value indicating that the corresponding packet of the second stream should be dropped.

In Example 2, the subject matter of Example 1 includes, a second network interface controller comprising one or more hardware processors and one or more memories, storing instructions, which when executed, cause the one or more hardware processors to perform second operations comprising: receiving the second stream of data packets; determining, using a value of an identifier of a second packet of the second stream of data packets, that the first data packet has already been received by the first network interface controller; and dropping the second packet in response to the determining.

In Example 3, the subject matter of Example 2 includes, wherein determining that the corresponding packet of the second stream of data packets having the value of the identifier has not already been received comprises: indexing into a lookup table using the value of the identifier; and determining that the packet of the second stream of data packets having the value of the identifier has not already been received using an entry of the lookup table corresponding to the value of the identifier.

In Example 4, the subject matter of Example 3 includes, wherein setting the stored value corresponding to the identifier comprises incrementing the entry of the lookup table corresponding to the identifier using an atomic count operation, and wherein determining that the first data packet has already been received comprises: indexing into the lookup table using the value of the identifier; and determining that the first data packet has already been received based on the entry of the lookup table corresponding to the identifier being non-zero.

In Example 5, the subject matter of Examples 2-4 includes, wherein determining, using the identifier of the first packet of the first stream of data packets, that the packet of the second stream of data packets has not already been received having the identifier comprises: identifying memory location for an output buffer for the data stream; indexing into the memory location using the value of the identifier; and determining that the first data packet has already been received based on the entry at the memory location.

In Example 6, the subject matter of Example 5 includes, wherein determining that the first data packet has already been received based on the entry at the memory location comprises: reading a value for the entry at the memory location; and determining that the first data packet has already been received based on the value of the entry at the memory location being non-zero.

In Example 7, the subject matter of Example 6 includes, wherein the second operations further comprise incrementing the value of the entry at the memory location in response to determining that the first data packet has already been received.

In Example 8, the subject matter of Examples 2-7 includes, wherein outputting the first data packet comprises transmitting the first data packet to a central processing unit on a data bus, and wherein the first network interface controller and the second network interface controller are separate circuits each connected to communicate on the data bus.

Example 9 is a machine-readable medium including instructions that, when executed by a network interface controller of a plurality of network interface controllers, cause the network interface controller to perform operations comprising: receiving a first stream of data packets redundant to a second stream of data packets; determining, using a value of an identifier of a received first packet of the first stream of data packets, that a corresponding packet of the second stream of data packets having the value of the identifier has not already been received by another network interface controller; in response to the determining, outputting the first data packet; and setting a stored value corresponding to the identifier, the stored value indicating that the corresponding packet of the second stream should be dropped.

In Example 10, the subject matter of Example 9 includes, wherein the determining that the corresponding packet of the second stream of data packets having the value of the identifier has not already been received comprises: indexing into a lookup table using the value of the identifier; and determining that the packet of the second stream of data packets having the value of the identifier has not already been received using an entry of the lookup table corresponding to the value of the identifier.

In Example 11, the subject matter of Examples 9-10 includes, wherein determining, using the identifier of the first packet of the first stream of data packets, that the packet of the second stream of data packets has not already been received having the identifier comprises: identifying a memory location for an output buffer for the data stream; indexing into the memory location using the value of the identifier; and determining that the first data packet has not already been received based on the entry at the memory location.

In Example 12, the subject matter of Example 11 includes, wherein setting the stored value corresponding to the identifier comprises incrementing the value of the entry at the memory location in response to determining that the first data packet has not already been received.

In Example 13, the subject matter of Example 12 includes, wherein the operation of outputting the first data packet comprises transmitting the first data packet to a central processing unit on a data bus.

Example 14 is a machine-readable medium including instructions that, when executed by a network interface controller of a plurality of network interface controllers, cause the network interface controller to perform operations comprising: receiving a first stream of data packets redundant to a second stream of data packets; determining, using a value of an identifier of a received packet of the second stream of data packets, that a corresponding packet of the first stream of data packets having the value of the identifier has already been received; and dropping the received packet in response to the determining that the corresponding packet of the first stream of data packets has already been received.

In Example 15, the subject matter of Example 14 includes, wherein the determining that the corresponding packet of the first stream of data packets having the value of the identifier has already been received comprises: indexing into a lookup table using the value of the identifier; and determining that the packet of the first stream of data packets having the value of the identifier has already been received using an entry of the lookup table corresponding to the value of the identifier.

In Example 16, the subject matter of Example 15 includes, wherein determining that the packet of the first stream of data packets having the value of the identifier has already been received using the entry of the lookup table comprises determining that the entry of the lookup table is non-zero.

In Example 17, the subject matter of Examples 14-16 includes, wherein determining, using the identifier of the first packet of the first stream of data packets, that the packet of the first stream of data packets has already been received having the identifier comprises: identifying a memory location for an output buffer for the data stream; indexing into the memory location using the value of the identifier; and determining that the packet of the first stream of data packets has already been received based on the entry at the memory location.

Example 18 is a method for reducing data traffic for redundant data streams, the method comprising: receiving, via a first network controller, a first stream of data packets; receiving, via a second network controller, a second stream of data packets redundant to the first stream of data packets; determining, by the first network controller and using a value of an identifier of a received packet of the first stream of data packets, that a corresponding packet of the second stream of data packets having the value of the identifier has not already been received; outputting, by the first network controller, the first data packet in response to the determining, determining, by the second network controller and using a value of an identifier of a second packet of the second stream of data packets, that the first data packet has already been received; and dropping, by the second network controller, the second packet in response to the determining.

In Example 19, the subject matter of Example 18 includes, wherein determining that the corresponding packet of the second stream of data packets having the value of the identifier has not already been received comprises: indexing into a lookup table using the value of the identifier; and determining that the packet of the second stream of data packets having the value of the identifier has not already been received using an entry of the lookup table corresponding to the value of the identifier.

In Example 20, the subject matter of Example 19 includes, wherein indexing into the lookup table comprises incrementing the entry of the lookup table corresponding to the identifier using an atomic count operation, and wherein determining that the first data packet has already been received comprises: indexing into the lookup table using the value of the identifier; and determining that the first data packet has already been received based on the entry of the lookup table corresponding to the identifier being non-zero.

In Example 21, the subject matter of Examples 18-20 includes, wherein determining, using the identifier of the first packet of the first stream of data packets, that the packet of the second stream of data packets has not already been received having the identifier comprises: identifying memory location for an output buffer for the data stream; indexing into the memory location using the value of the identifier; and determining that the first data packet has already been received based on the entry at the memory location.

In Example 22, the subject matter of Example 21 includes, wherein determining that the first data packet has already been received based on the entry at the memory location comprises: reading a value for the entry at the memory location; and determining that the first data packet has already been received based on the value of the entry at the memory location being non-zero.

In Example 23, the subject matter of Example 22 includes, in response to determining that the first data packet has already been received based on the entry at the memory location, incrementing the value of the entry at the memory location.

In Example 24, the subject matter of Examples 18-23 includes, wherein outputting the first data packet comprises transmitting the first data packet to a central processing unit on a data bus.

In Example 25, the subject matter of Example 24 includes, wherein the first network controller and the second network controller are separate circuits each connected to communicate on the data bus.

Example 26 is a system for reducing data traffic for redundant data streams, the system comprising: means for receiving a first stream of data packets; means for receiving a second stream of data packets redundant to the first stream of data packets; means for determining, using a value of an identifier of a received packet of the first stream of data packets, that a corresponding packet of the second stream of data packets having the value of the identifier has not already been received; means for outputting the first data packet in response to the determining that the corresponding packet of the second stream of data packets has not already been received; means for determining using a value of an identifier of a second packet of the second stream of data packets, that the first data packet has already been received; and means for dropping the second packet in response to the determining that the first data packet has already been received.

In Example 27, the subject matter of Example 26 includes, wherein the means for determining that the corresponding packet of the second stream of data packets having the value of the identifier has not already been received comprises: means for indexing into a lookup table using the value of the identifier; and means for determining that the packet of the second stream of data packets having the value of the identifier has not already been received using an entry of the lookup table corresponding to the value of the identifier.

In Example 28, the subject matter of Example 27 includes, wherein the means for indexing into the lookup table comprises means for incrementing the entry of the lookup table corresponding to the identifier using an atomic count operation, and wherein the means for determining that the first data packet has already been received comprises: means for indexing into the lookup table using the value of the identifier; and means for determining that the first data packet has already been received based on the entry of the lookup table corresponding to the identifier being non-zero.

In Example 29, the subject matter of Examples 26-28 includes, wherein the means for determining, using the identifier of the first packet of the first stream of data packets, that the packet of the second stream of data packets has not already been received having the identifier comprises: means for identifying memory location for an output buffer for the data stream; means for indexing into the memory location using the value of the identifier; and means for determining that the first data packet has already been received based on the entry at the memory location.

In Example 30, the subject matter of Example 29 includes, wherein the means for determining that the first data packet has already been received based on the entry at the memory location comprises: means for reading a value for the entry at the memory location; and means for determining that the first data packet has already been received based on the value of the entry at the memory location being non-zero.

In Example 31, the subject matter of Example 30 includes, means for incrementing the value of the entry at the memory location in response to determining that the first data packet has already been received based on the entry at the memory location.

In Example 32, the subject matter of Examples 26-31 includes, wherein the means for outputting the first data packet comprises means for transmitting the first data packet to a central processing unit on a data bus.

Example 33 is at least one machine-readable medium including instructions that, when executed by processing circuitry, cause the processing circuitry to perform operations to implement of any of Examples 1-32.

Example 34 is an apparatus comprising means to implement of any of Examples 1-32.

Example 35 is a system to implement of any of Examples 1-32.

Example 36 is a method to implement of any of Examples 1-32.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1.-25. (canceled)

26. A system for reducing data traffic for redundant data streams, the system comprising:
a first network interface controller comprising one or more hardware processors and one or more memories, storing instructions, which when executed, cause the one or more hardware processors to perform first operations comprising:
receiving a first stream of data packets redundant to a second stream of data packets;
determining, using a value of an identifier of a received packet of the first stream of data packets, that a corresponding packet of the second stream of data packets having the value of the identifier has not already been received;
in response to the determining, outputting the first data packet; and
setting a stored value corresponding to the identifier, the stored value indicating that the corresponding packet of the second stream should be dropped.

27. The system of claim 26, further comprising:
a second network interface controller comprising one or more hardware processors and one or more memories, storing instructions, which when executed, cause the one or more hardware processors to perform second operations comprising:
receiving the second stream of data packets;
determining, using a value of an identifier of a second packet of the second stream of data packets, that the first data packet has already been received by the first network interface controller; and
dropping the second packet in response to the determining.

28. The system of claim 27, wherein determining that the corresponding packet of the second stream of data packets having the value of the identifier has not already been received comprises:
indexing into a lookup table using the value of the identifier; and
determining that the packet of the second stream of data packets having the value of the identifier has not already been received using an entry of the lookup table corresponding to the value of the identifier.

29. The system of claim 28, wherein setting the stored value corresponding to the identifier comprises incrementing the entry of the lookup table corresponding to the identifier using an atomic count operation, and wherein determining that the first data packet has already been received comprises:
indexing into the lookup table using the value of the identifier; and
determining that the first data packet has already been received based on the entry of the lookup table corresponding to the identifier being non-zero.

30. The system of claim 27, wherein determining, using the identifier of the first packet of the first stream of data packets, that the packet of the second stream of data packets has not already been received having the identifier comprises:
identifying memory location for an output buffer for the data stream;
indexing into the memory location using the value of the identifier; and
determining that the first data packet has already been received based on an entry at the memory location.

31. The system of claim 30, wherein determining that the first data packet has already been received based on the entry at the memory location comprises:
reading a value for the entry at the memory location; and
determining that the first data packet has already been received based on the value of the entry at the memory location being non-zero.

32. The system of claim 31, wherein the second operations further comprise incrementing the value of the entry at the memory location in response to determining that the first data packet has already been received.

33. The system of claim 27, wherein outputting the first data packet comprises transmitting the first data packet to a central processing unit on a data bus, and wherein the first network interface controller and the second network interface controller are separate circuits each connected to communicate on the data bus.

34. A non-transitory machine-readable medium including instructions that, when executed by a network interface controller of a plurality of network interface controllers, cause the network interface controller to perform operations comprising:
receiving a first stream of data packets redundant to a second stream of data packets;
determining, using a value of an identifier of a received first packet of the first stream of data packets, that a corresponding packet of the second stream of data packets having the value of the identifier has not already been received by another network interface controller;
in response to the determining, outputting the first data packet; and
setting a stored value corresponding to the identifier, the stored value indicating that the corresponding packet of the second stream should be dropped.

35. The non-transitory machine-readable medium of claim 34, wherein the determining that the corresponding packet of the second stream of data packets having the value of the identifier has not already been received comprises:
indexing into a lookup table using the value of the identifier; and
determining that the packet of the second stream of data packets having the value of the identifier has not already been received using an entry of the lookup table corresponding to the value of the identifier.

36. The non-transitory machine-readable medium of claim 34, wherein determining, using the identifier of the first packet of the first stream of data packets, that the packet of the second stream of data packets has not already been received having the identifier comprises:
identifying a memory location for an output buffer for the data stream;
indexing into the memory location using the value of the identifier; and
determining that the first data packet has not already been received based on an entry at the memory location.

37. The non-transitory machine-readable medium of claim 36, wherein setting the stored value corresponding to the identifier comprises incrementing the value of the entry at the memory location in response to determining that the first data packet has not already been received.

38. The non-transitory machine-readable medium of claim 37, wherein the operation of outputting the first data packet comprises transmitting the first data packet to a central processing unit on a data bus.

39. A non-transitory machine-readable medium including instructions that, when executed by a network interface controller of a plurality of network interface controllers, cause the network interface controller to perform operations comprising:
receiving a first stream of data packets redundant to a second stream of data packets;
determining, using a value of an identifier of a received packet of the second stream of data packets, that a corresponding packet of the first stream of data packets having the value of the identifier has already been received; and
dropping the received packet in response to the determining that the corresponding packet of the first stream of data packets has already been received.

40. The non-transitory machine-readable medium of claim 39, wherein the determining that the corresponding packet of the first stream of data packets having the value of the identifier has already been received comprises:
indexing into a lookup table using the value of the identifier; and
determining that the packet of the first stream of data packets having the value of the identifier has already been received using an entry of the lookup table corresponding to the value of the identifier.

41. The non-transitory machine-readable medium of claim 40, wherein determining that the packet of the first stream of data packets having the value of the identifier has already been received using the entry of the lookup table comprises determining that the entry of the lookup table is non-zero.

42. The non-transitory machine-readable medium of claim 39, wherein determining, using the identifier of the first packet of the first stream of data packets, that the packet of the first stream of data packets has already been received having the identifier comprises:
identifying a memory location for an output buffer for the data stream;
indexing into the memory location using the value of the identifier; and
determining that the packet of the first stream of data packets has already been received based on an entry at the memory location.

43. A method for reducing data traffic for redundant data streams, the method comprising:
receiving, via a first network controller, a first stream of data packets;
receiving, via a second network controller, a second stream of data packets redundant to the first stream of data packets;
determining, by the first network controller and using a value of an identifier of a received packet of the first stream of data packets, that a corresponding packet of the second stream of data packets having the value of the identifier has not already been received;
outputting, by the first network controller, the first data packet in response to the determining,
determining, by the second network controller and using a value of an identifier of a second packet of the second stream of data packets, that the first data packet has already been received; and
dropping, by the second network controller, the second packet in response to the determining.

44. The method of claim 43, wherein determining that the corresponding packet of the second stream of data packets having the value of the identifier has not already been received comprises:
indexing into a lookup table using the value of the identifier; and
determining that the packet of the second stream of data packets having the value of the identifier has not already been received using an entry of the lookup table corresponding to the value of the identifier.

45. The method of claim 44, wherein indexing into the lookup table comprises incrementing the entry of the lookup table corresponding to the identifier using an atomic count operation, and wherein determining that the first data packet has already been received comprises:
indexing into the lookup table using the value of the identifier; and
determining that the first data packet has already been received based on the entry of the lookup table corresponding to the identifier being non-zero.

46. The method of claim 43, wherein determining, using the identifier of the first packet of the first stream of data packets, that the packet of the second stream of data packets has not already been received having the identifier comprises:
identifying memory location for an output buffer for the data stream;
indexing into the memory location using the value of the identifier; and
determining that the first data packet has already been received based on an entry at the memory location.

47. The method of claim 46, wherein determining that the first data packet has already been received based on the entry at the memory location comprises:
reading a value for the entry at the memory location; and
determining that the first data packet has already been received based on the value of the entry at the memory location being non-zero.

48. The method of claim 47, further comprising in response to determining that the first data packet has already been received based on the entry at the memory location, incrementing the value of the entry at the memory location.

49. The method of claim 43, wherein outputting the first data packet comprises transmitting the first data packet to a central processing unit on a data bus.

50. The method of claim 49, wherein the first network controller and the second network controller are separate circuits each connected to communicate on the data bus.
